(19) United States
(12) Patent Application Publication
(10) Pub. No.: US 2006/0202132 A1
(43) Pub. Date: Sep. 14, 2006

(54) Portable fluorescence detection unit adapted for eye protection

(76) Inventors: Janet Bee Yin Chua, Perak (MY); Yue Hoong Lau, Penang (MY); Rene Helbing, Palo Alto, CA (US)

Correspondence Address: AVAGO TECHNOLOGIES, LTD., P.O. BOX 1920, DENVER, CO, 80201-1920, US

(21) Appl. No.: 11/080,965

(22) Filed: Mar. 14, 2005

(51) Int. Cl. G01J 1/58

(52) U.S. Cl. 250/458.1; 250/461.1

(57) ABSTRACT

A handheld fluorescence detector that includes a handheld data processing system and a UV light source connected to the data processing system is disclosed. The UV light source illuminates an object to be scanned with light having a UV illumination wavelength. A safety mechanism inhibits the light from the UV light source from reaching an eye of a person in the vicinity of the UV light source at an intensity that would damage the eye. A fluorescence detector senses fluorescent light generated by the object in response to the illumination. The fluorescence detection can utilize a photodetector or a human observer. The detector can be included in a cellular telephone or PDA. Safety mechanisms that utilize baffles or total internal reflection to protect the user are described. In addition, interlock mechanisms that prevent the UV light source from being activated when no object is present can be incorporated.

### BACKGROUND OF THE INVENTION

Many detection problems depend on sensing a fluorescent dye that is excited by UV light. For example, many countries utilize currency that includes fluorescent dyes to make it more difficult to counterfeit the currency. The dyes are located in a specific pattern and are viewable with the aid of a UV light. In addition, different denomination bills have different dyes and/or dye patterns to further inhibit counterfeiting by printing larger denomination bills on the paper utilized for smaller denomination bills. Vending machines often include fluorescent imaging systems for determining the authenticity of currency that has been input to the machine. Similarly banks have scanners for detecting counterfeit bills.

UV LEDs are now available, and hence, an inexpensive, compact, fluorescent detection system can, in principle, be constructed for use by the average consumer. Counterfeit detection systems based on fluorescent dye detection are not, however, readily available to the general public for two reasons. First, the use of such a detection system would require the user to carry a portable viewing system for verifying the authenticity of the currency. Since the need for such verification occurs relatively rarely, most consumers are not willing to carry a separate illumination system and scanner for this purpose.

Second, such detection schemes require the use of UV light sources. Such light sources present significant safety hazards. The intensity of UV light needed to activate the dyes is sufficient to cause damage to a user's eyes. Hence, there are significant safety and legal liability problems with any consumer device that can illuminate the user's eyes with the UV light.

### SUMMARY OF THE INVENTION

The present invention includes a handheld fluorescence detector that includes a handheld data processing system and a UV light source connected to the data processing system. The UV light source illuminates an object to be scanned with light having a UV illumination wavelength. The present invention includes a safety mechanism that inhibits the light from the UV light source from reaching an eye of a person in the vicinity of the UV light source at an intensity that would damage the eye. A fluorescence detector senses fluorescent light generated by the object in response to the illumination. In one embodiment, the detector includes a photodetector that detects fluorescent light emitted from the object in response to the illumination. The data processing system receives a signal from the photodetector and displays an indication of the presence of the fluorescent light on a display. In another embodiment, the detector is a human observer and the fluorescence detector includes a transparent window in a baffle system, the transparent window allowing a user of the detector to view fluorescent light emitted from the object while blocking UV light from reaching the user at an intensity that could harm the user. In one embodiment, the safety mechanism includes a baffle that allows an object to be irradiated by the UV light while preventing a user of the detector from viewing the UV light source. The baffle may include a transparent window in the baffle that allows a user of the detector to view fluorescent light emitted from the object while blocking UV light from reaching the user at an intensity that could harm the user. In one embodiment, the system includes an object sensing mechanism that generates an object present signal if an object is positioned to be irradiated by the UV light source and an interlock that prevents the UV light source from generating UV light at an intensity that would damage a user's eye when the object present signal is not generated. In one embodiment, the safety mechanism includes an optical enclosure having a transparent surface from which the UV light is internally reflected and wherein the object to be scanned is placed adjacent to the surface such that a surface of the object is within an electric field generated by the UV light. In one embodiment of this type, the fluorescence detector views the object through the transparent surface. Embodiments in which the handheld data processing system is a cellular telephone or PDA can also be constructed. One embodiment utilizes a cellular telephone that includes first and second halves that fold together when a user thereof is not talking on the cellular telephone, an object to be scanned is passed between the first and second halves when the first and second halves are folded together.

### BRIEF DESCRIPTION OF THE DRAWINGS

FIG. 1 illustrates one embodiment of a fluorescent detection system according to the present invention.

FIG. 2 is a cross-sectional view of a fluorescent detector according to another embodiment of the present invention.

FIGS. 3A and 3B illustrate another embodiment of a fluorescent detection system according to the present invention.

FIG. 4 illustrates a complete scanning system that incorporates a detection head on a handheld device having a controller and display.

FIG. 5 is a prospective view of a cellular telephone that incorporates a fluorescent detection system according to one transmissive embodiment of the present invention.

FIG. 6 illustrates a cellular telephone in the closed state during the scanning of a bill.

FIG. 7 is a prospective view of a cellular telephone in the open state.

FIG. 8 is a top view of a cellular telephone that includes a fluorescent light detector according to one embodiment of the present invention.

FIG. 9 illustrates a fluorescent light detector according to another embodiment of the present invention.

### DETAILED DESCRIPTION OF THE PREFERRED EMBODIMENTS OF THE INVENTION

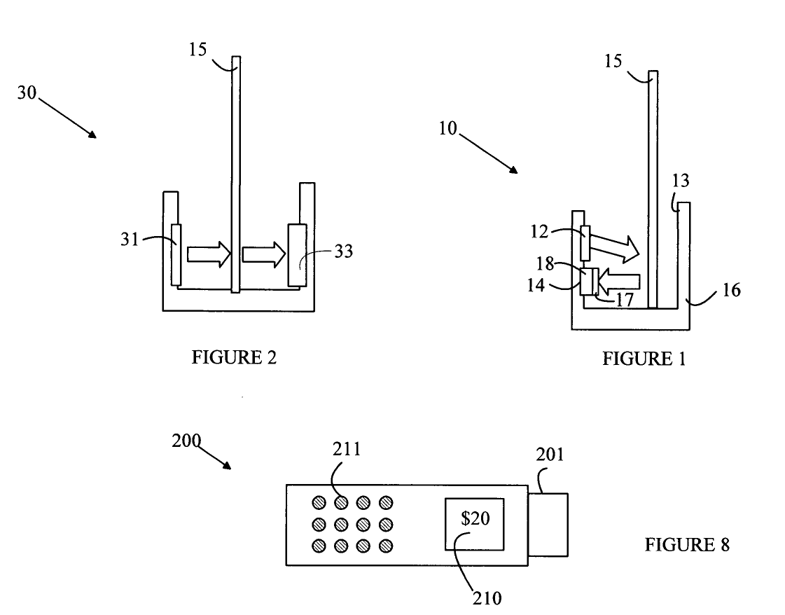

The present invention overcomes the safety problems discussed above by providing a detection device that prevents the user from illuminating his or her eyes with UV light at an intensity that could cause damage to the eye. Refer now to FIG. 1, which illustrates one embodiment of a fluorescent detection system according to the present invention. Detection system 10 includes a UV light source 12 and a fluorescence detector 14. A bank note 15 that is to be scanned is passed through the detector in a direction perpendicular to the plane of the figure. Detection system 10 includes an enclosure 16 that prevents the UV light generated by light source 12 from reaching the eye of a user.

UV light source 12 is preferably an UV-emitting LED. Light source 12 preferably emits UV light in the band from 350 to 400 nm.

Detector 14 includes a filter 17 and one or more photodetectors 18 that are sensitive to light in the fluorescent emission band of interest. Since the bank note is drawn past the detector, a single detector can form a one-dimensional image of the bank note along a predetermined scan path that is determined by the dimensions of enclosure 16. If only the presence of the fluorescent dye is to be detected, a single photodiode is sufficient. If a more detailed two-dimensional image is desired, an array of photodiodes can be utilized.

Filter 17 blocks any UV light that is reflected by the object being scanned from reaching the photodetectors. In one embodiment, filter 17 is a band-pass filter having a narrow band centered at the wavelength of the fluorescent band or bands of interest. The band-pass filter embodiment provides increased signal-to-noise, since it blocks visible light that leaks into enclosure 16 from outside enclosure 16.

Filter 17 can be eliminated in embodiments in which the UV light source is pulsed on and off. If the decay time of the excited phosphor is long compared to the length of the UV light pulse, the phosphor will continue to emit light after the UV light is turned off. In such embodiments, the fluorescent light is only detected between UV pulses, and hence, the background caused by the reflection or scattering of the UV light is not significant.

To further reduce the possibility of exposing the user to UV, detection system 10 can also include a bill detection mechanism for detecting the absence of a bill in the scanning region. An interlock mechanism is then utilized to prevent UV light source 12 from generating UV light at a level that could harm a user's eyes when no bill is present. Such a bill detection system preferably utilizes the components of the bill scanning system to minimize the cost of providing this additional safety feature.

The presence or absence of a bill in enclosure 16 can be detected by using the bill to block or reflect light. The light source and detector utilized for this measurement can be a separate light source and detector or the UV light source and fluorescence detector. To use the fluorescence detector and UV light source for this function, the fluorescence detector must be able to detect light in both the UV and fluorescent wavelength bands, and hence, a detector that lacks the band pass filter discussed above must be utilized. As noted above, such a detector can be used if the fluorescence measurements are performed by pulsing the UV light source to activate the fluorescent dye and then detecting the fluorescent light during the period in which the UV light source is off. In such systems, the presence of the bill can be detected by observing the light received by the photodetector when the UV light is on. The wall 13 of the enclosure that is opposite UV light source 12 includes a material that absorbs any UV light reaching that wall, and hence, no signal is recorded by photodetector 14 when the bill is absent. When the bill is placed in the enclosure, part of the UV light is scattered or reflected by the surface of the bill, and hence, light is detected by photodetector 14. During the bill detection phase, the pulse lengths and/or UV light intensity are maintained at a level that will not damage a person's eye.

When the bill detection system determines that a bill is in the enclosure, the UV light is switched to a high output power mode and the bill is scanned for fluorescence. However, the detection system continues to measure the UV light received during the actual UV pulses to determine if the bill is no longer present. When the bill is removed from the enclosure, the UV light again returns to its low power mode.

The bill detection system can also operate using a separate detector and/or light source. For example, light source 12 can include a second LED that emits light in a safe wavelength band. In such an embodiment, a second photodiode in photodetector 14 can be utilized to sense the presence of light in this safe wavelength band. In such an embodiment, the bill detection system is completely independent of the fluorescent scanning system, and hence, the photodiode used to detect the fluorescent light can utilize the blocking filter discussed above, and the UV LED can operate in a continuous mode during the scanning operation.

The above-described embodiments utilize a reflective geometry in which the UV light source and detector are on the same side of the bill or other object being scanned. In principle, a transmissive geometry can also be utilized if the fluorescent dye can be illuminated through the object and the fluorescent light can escape the object to be detected. Refer now to FIG. 2, which is a cross-sectional view of a fluorescent detector 30 according to another embodiment of the present invention. Fluorescence detector 30 includes a UV light source 31 that illuminates an object 15, such as a bank note, with UV light. The fluorescent light generated in object 15 is detected by photodetector 33, which is located on the opposite side of object 15 from UV light source 31.

The above-described embodiments of the present invention depend on some form of mechanical baffle to block light from the UV light source from reaching the eyes of a person in the vicinity of the detector. Such embodiments limit the object that is being scanned to objects that can pass through the enclosure. In addition, a user may be able to extract the UV light from the device by placing a highly reflective surface, such as a sheet of aluminum foil, in the device.

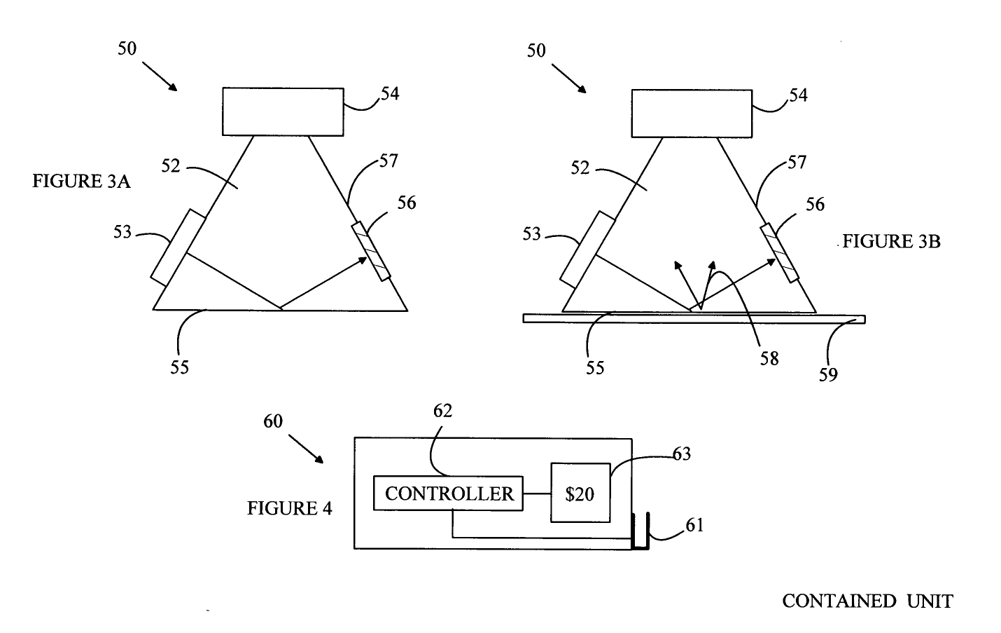

Refer now to FIGS. 3A and 3B, which illustrate another embodiment of a fluorescent detection system according to the present invention. Fluorescent detection system 50 includes a transparent optical housing 52, a UV light source 53, and a fluorescent detector 54. The angle of incidence of the UV light on surface 55 and the index of refraction of the material from which housing 52 is constructed are chosen such that the UV light suffers total internal reflection at surface 55. The reflected UV light is preferably absorbed by region 56 on surface 57. The absorption mechanism should be resistant to physical wear. For example, a UV absorbing material can be incorporated in the prism material in the vicinity of region 56. Alternatively, a UV absorbing coating can be applied to the outer surface of housing 52 in the vicinity of region 56. When no object is present in the region adjacent to surface 55, all of the light is absorbed by region 56, and hence, no light reaches photodetector 54.

Refer now to FIG. 3B. Fluorescent detection system 50 is based on the observation that a portion of the electric field from the UV light beam that is reflected at surface 55 actually extends outside housing 52 by a sufficient distance to excite a fluorescent dye on the surface of a bill 59 placed near or in contact with that surface. However, the distance in question is too small to allow a user to irradiate the retina of his or her eye.

A portion of the fluorescent light generated by the excited dye will enter housing 52 and reach photodetector 54. Since the fluorescent light 58 is emitted in all directions, detector 54 can be positioned such that photodetector 54 can receive a portion of this light without receiving a significant amount of UV light. Hence, a filter for blocking the UV light is not needed. However, a band pass filter can be included in photodetector 54 to improve the signal-to-noise ratio of fluorescent detection system 50.

Refer now to FIG. 4, which illustrates a complete scanning system 60 that incorporates a detection head 61 on a handheld device having a controller 62 and display 63. Detection head 61 can be any of the above-discussed embodiments. The controller executes the scanning functions and the bill detection functions discussed above if such a detection system is incorporated in the device. The controller processes the signals from the photodetector or detectors to determine the authenticity of the bill and, optionally, the denomination of the bill. The display preferably provides an alphanumeric indication of the authenticity of the bill as well as a readout of the bills denomination.

If the determination of the denomination depends on knowledge of the precise wavelengths emitted by the fluorescent dye in the bill, the photodetectors in detection head 61 can include one photodetector/band pass filter for each of the possible emission wavelengths. To minimize the number of photodiode/filter pairs, a manually changeable filter can be provided for each country of interest.

As noted above, the typical consumer does not want to carry a separate scanning device for detecting counterfeit money. Hence, embodiments of the present invention that are incorporated in cellular telephones or other handheld devices, such as PDAs are preferred. Such handheld devices already include a screen and firmware that is adapted for displaying both images and text. In addition, the amount of power required to operate the fluorescent detector will not represent a significant drain of the device's batteries.

So called “flip phones” are particularly attractive candidates for incorporating a fluorescent scanner according to the present invention. Such phones include two sections that fold together when the user is not using the phone for a making a call. A small force holds the two halves together when the phone is in the closed configuration. However, a bill can still be drawn between the two halves in the closed state.

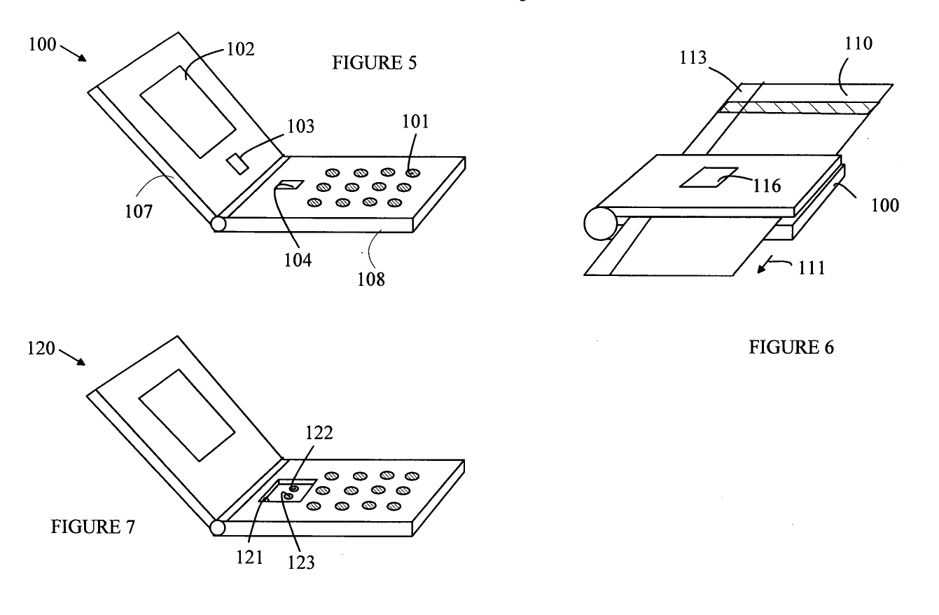

Refer now to FIG. 5, which is a prospective view of a cellular telephone 100 that incorporates a fluorescent detection system according to one transmissive embodiment of the present invention. FIG. 5 shows cellular telephone 100 in the open state. In which the two halves 107 and 108 are separated from one another. Cellular telephone 100 includes a keypad 101 and a display 102 that are used during the conventional operation of the telephone. In addition, cellular telephone 100 includes a UV light source 103 and a fluorescent light detector 104 that are positioned on opposite halves of cellular telephone 100 such that UV light source 103 will be positioned under fluorescent light detector 104 when the two halves of phone 100 are closed.

Refer now to FIG. 6, which illustrates Cellular telephone 100 in the closed state during the scanning of a bill 110. The bill is scanned by pulling the bill through the two closed halves as indicated by arrow 111. Fluorescent light detector 104 and UV light source 103 are positioned such that the portion of bill 110 that passes between these elements contains the fluorescent mark in question. For example, the fluorescent mark can be in the form of a stripe 113 across bill 110.

Many flip phones include a second auxiliary display 116 that is adapted for displaying text information such as the date, time, and caller identification data. This display is utilized to display the results of the scan, i.e., counterfeit vs. real and the denomination of the bill.

Similarly, reflective embodiments of the present invention can be incorporated in such telephones. Refer now to FIG. 7, which is a prospective view of a cellular telephone 120 in the open state. In the case of a reflective embodiment, the light source 122 and photodetector 123 are preferably mounted such that these elements are separated from the bill by a small distance when the bill is drawn between the two halves of the flip phone. For example, the light source and photodetector can be mounted in a shallow well 121.

Total internal reflection embodiments such as those discussed with reference to FIGS. 3A and 3B above are well adapted for mounting on the outside of a cellular telephone or PDA. The detector is then physically moved over the bill or other object in question while depressing a key or other button. While the key is depressed, the UV light source is activated and the output of the fluorescent light detector is processed by the controller in the handheld device. Once again, the results of the scan are displayed on the handheld device display. An embodiment of this type is shown in FIG. 8, which is a top view of a cellular telephone 200 that includes a fluorescent light detector 201 according to one embodiment of the present invention. Cellular telephone 200 includes a display 210 and a keypad 211. The key that is utilized to activate the scanning can be any of the keys on cellular telephone 211, a combination of these keys, or a separate key that is utilized solely for this purpose.

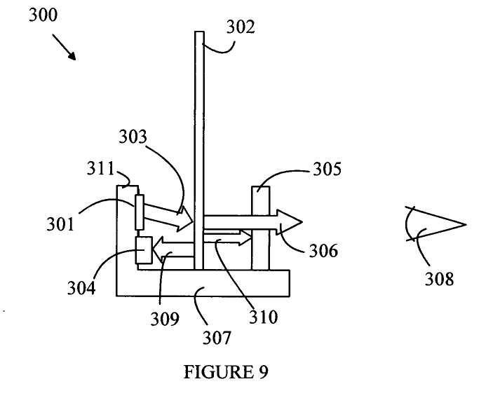

The above-described embodiments utilize one or more photodiodes to detect the fluorescent light that is emitted from the object being scanned in response to the irradiation of the object with the UV light. However, embodiments in which the user detects the presence of the fluorescent material by looking at the irradiated object can also be constructed. Refer now to FIG. 9, which illustrates a fluorescent light detector 300 according to another embodiment of the present invention. Fluorescent light detector 300 utilizes both visual observation by a user 308 and a photodetector 304 to detect the fluorescent material in an object 302 such as a bill or other partially transparent object. Object 302 is irradiated with UV light 303 from UV LED 301 as described above. Fluorescent light that is generated in the direction shown at 309 is detected by photodetector 304. The fluorescent light that leaks through object 302 in the direction shown at 306 is viewed by user 308 through a transparent window 305 in baffle 307. Window 305 is constructed from a material that absorbs any UV light 310 that strikes window 305, and hence, the user's eye is protected from damage.

It should be noted that embodiments in which photodetector 304 are omitted could also be constructed. Similarly, embodiments in which wall 311 of baffle 307 is transparent to the fluorescent light while opaque to UV light can also be constructed.

Various modifications to the present invention will become apparent to those skilled in the art from the foregoing description and accompanying drawings. Accordingly, the present invention is to be limited solely by the scope of the following claims.

What is claimed is:

1. A handheld fluorescence device comprising:
a handheld data processing system;
a UV light source connected to said data processing system that illuminates an object to be scanned with light having a UV illumination wavelength;
a safety mechanism that inhibits said light from said UV light source from reaching an eye of a person in the vicinity of said UV light source at an intensity that would damage said eye; and
a fluorescence detector for sensing fluorescent light generated by said object in response to said illumination.

2. The device of claim 1 wherein said fluorescence detector comprises a photodetector that detects fluorescent light emitted from said object in response to said illumination, wherein said data processing system receives a signal from said photodetector and displays an indication of the presence of said fluorescent light on a display.

3. The device of claim 1 wherein said fluorescence detector comprises a transparent window in a baffle system, said transparent window allowing a user of said detector to view fluorescent light emitted from said object while blocking UV light from reaching said user at an intensity that could harm said user.

4. The device of claim 2 wherein said safety mechanism comprises a baffle that allows an object to be irradiated by said UV light while preventing a user of said detector from viewing said UV light source.

5. The device of claim 4 wherein said baffle comprises a transparent window in said baffle, said transparent window allowing a user of said detector to view fluorescent light emitted from said object while blocking UV light from reaching said user at an intensity that could harm said user.

6. The device of claim 2 further comprising an object sensing mechanism that generates an object present signal if an object is positioned to be irradiated by said UV light source and an interlock that prevents said UV light source from generating UV light at an intensity that would damage a user's eye when said object present signal is not generated.

7. The device of claim 2 wherein said safety mechanism comprises an optical enclosure having a transparent surface from which said UV light is internally reflected and wherein said object to be scanned is placed adjacent to said surface such that a surface of said object is within an electric field generated by said UV light.

8. The device of claim 7 wherein said photodetector views said object through said transparent surface.

9. The device of claim 2 wherein said photodetector forms an image of a portion of said object.

10. The device of claim 2 wherein said handheld data processor comprises a cellular telephone.

11. The device of claim 10 wherein said cellular telephone comprises first and second halves that fold together when a user thereof is not talking on said cellular telephone and wherein an object to be scanned is passed between said first and second halves when said first and second halves are folded together.

12. The device of claim 2 wherein said handheld data processor comprises a PDA.

13. A method for detecting the presence of a fluorescent compound on an object, said method comprising:
providing a handheld data processing unit having a UV light source;
exposing said object to UV light while protecting a person in the vicinity of said object from being exposed to said UV light at an intensity that could damage that person's eye; and
detecting fluorescent light generated by said object in response to said UV light;

14. The method of claim 13 further comprising providing a display screen; and
providing an indication of the presence of said fluorescent light on said display screen.

15. The method of claim 13 wherein said handheld device comprises a cellular telephone.

16. The method of claim 13 wherein said handheld device comprises a PDA.

17. The method of claim 14 wherein said object comprises currency in the form of a bill and wherein an indication of validity for said currency is displayed on said display.

18. The method of claim 17 wherein said indication of validity includes the denomination of said bill.
